(19) United States
(12) Patent Application Publication
(10) Pub. No.: US 2004/0179096 A1
(43) Pub. Date: Sep. 16, 2004

(54) Imaging system using theta-theta coordinate stage and continuous image rotation to compensate for stage rotation

(75) Inventors: Mark R. Harless, Plymouth, MN (US); Cory M. Watkins, Chanhassen, MN (US)

Correspondence Address: DICKIE BILLIG & CZAJA, PLLC, ATTN: JOHN VASUTA, 100 SOUTH FIFTH STREET, SUITE 2250, MINNEAPOLIS, MN, 55402, US

(73) Assignee: August Technology Corp

(21) Appl. No.: 10/675,807

(22) Filed: Sep. 30, 2003

Related U.S. Application Data
(60) Provisional application No. 60/414,983, filed on Sep. 30, 2002.

(51) Int. Cl. H04N 7/18

(52) U.S. Cl. 348/77

(57) ABSTRACT

A method for controlling a theta-theta coordinate stage moves an object relative to an imaging system. While moving the object, the object image is rotated to compensate for object rotation. Orientations of features in the image are preserved, and removal of apparent rotation in the image reduces operator confusion while directing movement of the object. Angular velocity of the object motion is controlled so that image shift speed is independent of the radial position of the point being viewed. An edge detector measures the edge position of the object while the theta-theta coordinate stage rotates the object. A prealignment process determines position and orientation of the object from measured edge positions. A further alignment process uses automated pattern recognition to identify features on the object when the image is rotated so that orientations of the feature are approximately known.

### CROSS-REFERENCE TO RELATED APPLICATIONS

This application claims priority to, and incorporates herein by reference an entirety of, U.S. Provisional Patent Application Serial No. 60/414,983, filed Sep. 30, 2002.

### BACKGROUND OF THE INVENTION

1. Technical Field

The present invention relates to measurement and inspection systems that use theta-theta coordinate stages to position samples.

2. Background Information

Many stages are designed as an X Y translation system for scanning wafers using sensors such as microscopes, distance measurement sensors, film thickness sensors, and spectrographic sensors. The disadvantage of this type of system is the following: Cost due to the large lengths of travel and desired accuracy, inspection time is increased due to the turn around times, particle contamination is increased due to turbulent air flow, and large footprint.

Other proposed stages are of a polar coordinate stage design (radius, theta). This method improves upon the XY design for reduced footprint, cost, and decreased inspection times. However, linear drive the polar coordinate configuration requires a linear drive that in turn creates particle contamination and inherently obscures portions of the object being inspected, impeding the ability to inspect the object from both sides simultaneously.

### SUMMARY OF THE INVENTION

The present invention is a device including a theta-theta coordinate stage that includes a rotary arm drive and a rotatable platform, wherein an object to be imaged is placed on the rotatable platform, an imaging system, an image rotator, and a control system coupled to the theta-theta coordinate stage and the image rotator, wherein the control system controls the image rotator and causes the image rotator to rotate an image to compensate for rotation of the rotatable platform and preserve orientations of features in the image.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a schematic illustration of a theta-theta coordinate stage system in accordance with the present invention useful as part of a wafer inspection system;

FIG. 2 is a schematic illustration, of an alternative embodiment stage system in accordance with the present invention; and

FIG. 3 is a schematic illustration with portions in block form, of an object inspection device in accordance with the present invention.

Similar numerals refer to similar parts throughout the drawings.

### DETAILED DESCRIPTION OF THE PREFERRED EMBODIMENT

The present invention provides a novel theta-theta coordinate stage platform system which removes the linear drive obstruction, reduces footprint, decreases inspection time, decreases cost over both XY and polar stages, and improves laminar airflow over the wafer surface.

In general, one rotary axis rotates the object to be inspected while a second rotary axis scans the sensor in an arc across the object surface. This method allows for the provision of one or more sensor arms on both the top side and bottom side of the object to be inspected.

For example, FIG. 1 illustrates one embodiment of a theta-theta coordinate stage system 10 in accordance with the present invention, useful as part of a wafer inspection device. In general terms, the system 10 includes a rotatable platform 12, a primary rotary arm 14, a primary rotary drive 16, a sensor 18, a secondary rotary arm 20, and a secondary rotary drive 22. The rotatable platform 12 is adapted to maintain an object to be imaged, for example a wafer (not shown), and is rotatable about a platform rotation axis A. The primary rotary drive 16 rotates the rotatably platform 12 via the primary rotary arm 14. To this end, while the primary rotary arm 14 is shown in FIG. 1 as extending transversely relative to the rotatable platform 12, the rotary arm 14 can be axially aligned with the platform rotation axis A; regardless, a rotary drive axis of the primary rotary arm 14/primary rotary drive 16 intersects the platform rotation axis A. As described below, the sensor 18 can assume a wide variety of forms, and information from the sensor 18 can be used for a number of different applications. Regardless, the sensor 18 is mounted to the secondary rotary arm 20 that in turn is driven by the secondary rotary drive 22 about a sensor or optic axis B.

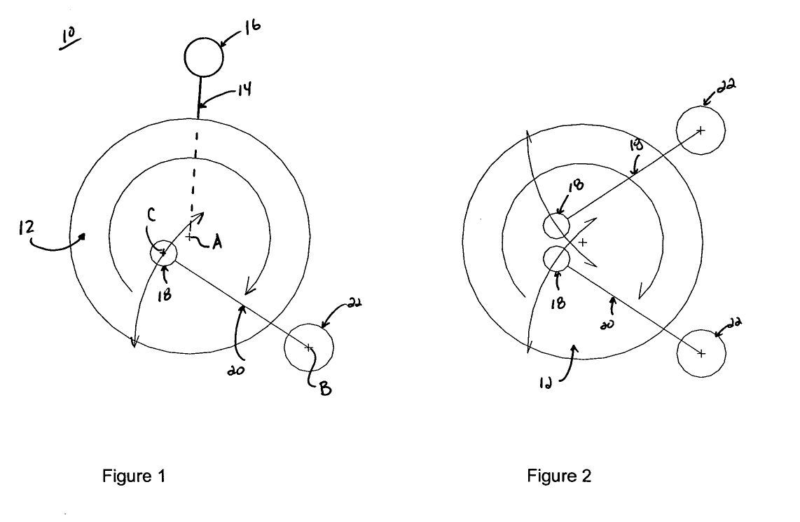

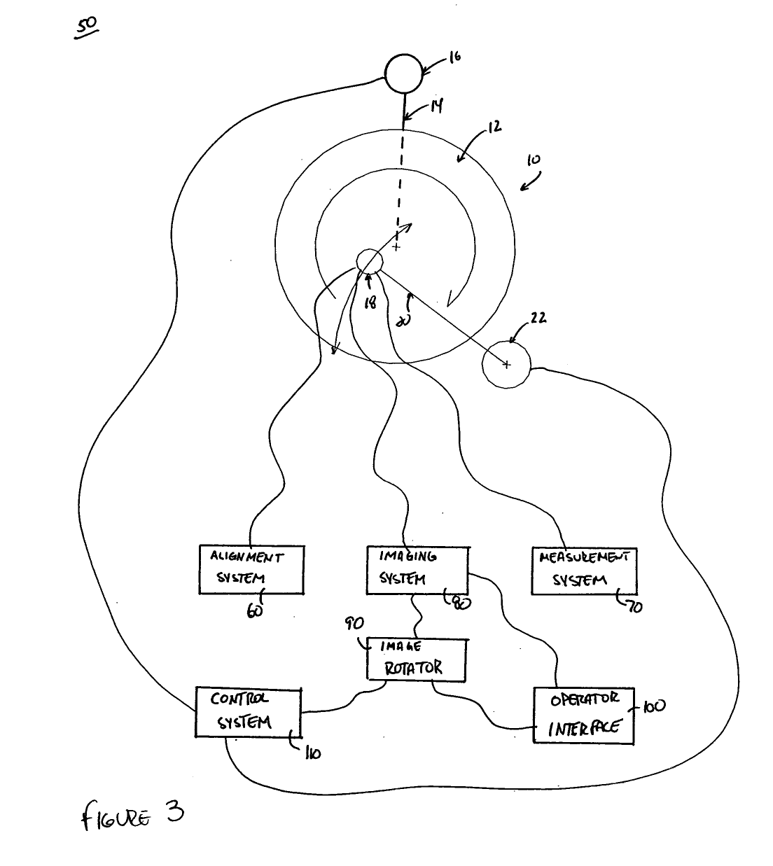

With the one embodiment of FIG. 1, the system 10 is provided with one of the sensors 18. Alternatively, and as shown in FIG. 2, two or more of the sensors 18 (and corresponding secondary rotary arm(s) 20 and secondary rotary drive(s) 22) can be provided. Even further, the platform 12 can form a central aperture (not shown) within which the object to be inspected (not shown) is seated. With this alternative configuration (or other similar designs), opposing surfaces of the object to be inspected are exposed, such that sensors 18 can be provided “above” and “below” the opposing surfaces of the object.

With further reference to FIG. 3, the stage system 10 can be used as part of an object inspection device 50, for example a wafer inspection device, that otherwise includes one or more additional features adapted to control operation of the stage system 10 and/or process information generated by the sensor(s) 18. For example, FIG. 3 illustrates the device 50 as further including an alignment system 60, a measurement system 70, an imaging system 80, an image rotator 90, a control system 100, and an operator interface 110. These features are described in greater detail below, it being understood that one or more of the so-described features can be eliminated and still fall within the scope of the present invention.

The device 50 includes the theta-theta coordinate stage system 10 that includes the rotary arm drive 22 and a rotatable platform 12, wherein an object to be imaged (not shown) is placed on the rotatable platform 12.

The device 50 also includes the alignment system 60. This system may include an edge detector and a processing system that identifies a position of the sample from measurements that the edge detector takes (via the sensor 18) while the theta-theta coordinate stage 10, and in particular the rotatable platform 12, rotates the object to be imaged. The alignment system 60 may further include a pattern recognition module that identifies a feature in the image generated by the sensor 18 as rotated by the image rotator 90 (described below) and from identification of the feature, determines a position of the object and/or relevant portion thereof.

The device 50 may also include the measurement system 70 for measuring a physical property (via the sensor 18) of a portion of the object to be imaged that the theta-theta coordinate stage system 10 moved into a field of view of the measurement system (e.g., the sensor 18).

The device 50 further includes the imaging system 80 for obtaining an image, via the sensor 18, of a portion of the (or object to be inspected) that the theta-theta coordinate stage system 10 moved into a field of view of the imaging system 80, and the image rotator 90 that rotates the so-acquired image to compensate for rotation of the sample by the theta-theta coordinate stage.

In one embodiment, the imaging system 80, including the sensor 18, may be a microscope such as a confocal microscope, a scanning probe microscope, or a scanning microscope including the following types: a scanning electron-beam microscope or scanning ion-beam microscope. The imaging system 80, including the sensor 18, also may include a video camera.

In one embodiment, the image rotator 90 comprises an image capture and image processing system that captures the image from the video camera (e.g., the sensor 18) and rotates the image by an amount selected by the control system. The image rotator 90 may include a set of beam deflectors (not shown) that changes orientation of an area scanned on the surface of the object, and/or the image rotator 90 may be a rotatable dove prism on an optical axis of the microscope (e.g., the sensor 18). The image rotator 90 includes software which is capable of rotating a video image from the video camera (e.g., the sensor 18), and specifically the software which allows rotation of a digitized image. The image rotator 90 may also include an optical element for rotating the image.

The device 50 even further includes the control system 100 that is coupled to the theta-theta coordinate stage system 10 and the image rotator 90, wherein the control system 100 controls the image rotator 90 and causes the image rotator 90 to rotate an image to compensate for rotation of the rotatable platform 12 and preserve orientations of features in the image (such as generated by the sensor 18). The control system 100 applies control signals to the theta-theta coordinate stage system 10 to control movement of the object (via the platform 12) and applies control signals to the image rotator 90 to compensate for the rotation of the object, as well as, in one embodiment, controlling operation of the secondary rotary drive 22.

Specifically, the control system 100 may include a processor executing a module that converts Cartesian coordinate input commands relative to an image of the object to theta-theta coordinate stage system 10 commands and image rotator 90 commands.

The operator interface 110 is also part of the system 50, and includes a monitor (not shown) for viewing the image. The operator interface can further comprise a control coupled to send to the control system 100 commands indicating a desired motion of the image viewed on the monitor. The operator interface 110 may further include a video camera and a display monitor.

In more detail, the rotatable platform 12 has a rotation axis A that intersects a rotary drive axis. There is also an optic axis C of the imaging system 80 (e.g., the sensor 18) that is moved along the axis of one of the rotary drives or images coincident to one of the rotary axis.

In operation, a setting of the primary rotary drive 16 indicates a displacement of the rotary drive relative to a zero displacement position. An orientation monitoring system (not shown) can be provided that measures an angular displacement of the rotatable platform relative to a zero angular displacement setting.

In more detail as to one of the device embodiments, the device includes a rotary platform for rotating the object, one or more secondary rotary drives for moving a sensor across the rotating object, one or more sensors mounted to one or more rotary drives, and a control system for controlling the position of the object while acquiring the sensor data. At least one of the sensors is used to inspect the top surface of the object, and at least one sensor is used to inspect the bottom surface of the object.

In more detail as to the method of viewing an object, the method in general involves the following steps: mounting the object on a theta-theta coordinate stage, viewing an image of a region of the object, using the theta-theta coordinate stage to move the object, and rotating the image of the object as the object moves so that features in the image retain a fixed orientation while the object rotates.

Another method of operation of the present invention includes the steps of: mounting a sample on a theta-theta coordinate stage, wherein the sample as mounted has a position known to a first accuracy, measuring edge locations of the sample while the theta-theta coordinate stage rotates the sample, prealigning the sample by determining the position of the sample from the edge locations, wherein the prealigning determines the position of the sample to a second accuracy, using the theta-theta coordinate stage to move the sample so that a view area of an imaging system contains a first feature, rotating an image formed by the imaging system to compensate for rotation of the sample by the theta-theta coordinate stage, using a pattern recognition module to process the rotated image and identify a first location corresponding to the first feature, and measuring a property of the sample at a point having a position identified relative to the first location. This method may further include using the theta-theta coordinate stage to move the sample so that the view area of the imaging system contains a second feature, rotating the image formed by the imaging system to compensate for a rotation of the sample by the theta-theta coordinate stage while moving to the second feature, using the pattern recognition module on the rotated image to identify a second location corresponding to the second feature, and using identification of the first and second locations to determine the position of the sample to a third accuracy, or alternatively, the method may further include using the theta-theta coordinate stage to move the sample so that a plurality of points are sequentially positioned for measurement of the property of the sample at the points, and sequentially measuring the property of the sample at the measurement points.

What is claimed is:

1. A device comprising:
a theta-theta coordinate stage that includes a rotary arm drive and a rotatable platform, wherein an object to be imaged is placed on the rotatable platform;
an imaging system;
an image rotator; and
a control system coupled to the theta-theta coordinate stage and the image rotator, wherein the control system controls the image rotator and causes the image rotator to rotate an image to compensate for rotation of the rotatable platform and preserve orientations of features in the image.

2. The device of claim 1, wherein the control system applies control signals to the theta-theta coordinate stage to control movement of the object and applies control signals to the image rotator to compensate for the rotation of the object.

3. The device of claim 2, further comprising an operator interface including a monitor for viewing the image.

4. The device of claim 3, wherein the operator interface further comprises a control coupled to send to the control system commands indicating a desired motion of the image viewed on the monitor.

5. The device of claim 1, wherein the rotatable platform has a rotation axis that intersects a rotary drive axis.

6. The device of claim 5, an optic axis of the imaging system is moved along the axis of one of the rotary drives or images coincident to one of the rotary axis.

7. The device of claim 1, a setting of the rotary drive indicates a displacement of the rotary drive relative to a zero displacement position.

8. The device of claim 1, further comprising an orientation monitoring system that measures an angular displacement of the rotatable platform relative to a zero angular displacement setting.

9. The device of claim 1, further comprising a video camera and a display monitor.

10. The device of claim 9, wherein the image rotator comprises an image capture and image processing system that captures the image from the video camera and rotates the image by an amount selected by the control system.

11. The device of claim 1, wherein the imaging system comprises a microscope.

12. The device of claim 11, wherein the image rotator comprises a rotatable dove prism on an optical axis of the microscope.

13. The device of claim 11, further comprising a video camera and a display monitor.

14. The device of claim 13, wherein the image rotator comprises a rotatable dove prism on an optical axis of the microscope.

15. The device of claim 13, the image rotator comprises software which is capable of rotating a video image from the video camera.

16. The device of claim 1, wherein the imaging system comprises a scanning probe microscope.

17. The device of claim 1, wherein the imaging system comprises a scanning microscope.

18. The device of claim 17, further comprising an image processing system and display monitor.

19. The device of claim 17, wherein the image rotator comprises a set of beam deflectors that changes orientation of an area scanned on the surface of the object.

20. The device of claim 17, wherein the scanning microscope is a scanning electron-beam microscope.

21. The device of claim 17, wherein the scanning microscope is a scanning ion-beam microscope.

22. The device of claim 1, wherein the imaging system comprises a confocal microscope.

23. The device of claim 22, further comprising an image processing system and a display monitor.

24. The device of claim 1, wherein the image rotator comprises a rotatable dove prism.

25. The device of claim 1, wherein the image rotator comprises software which allows rotation of a digitized image.

26. The device of claim 1, wherein the control system comprises a processor executing a module that converts Cartesian coordinate input commands relative to an image of the object to theta-theta coordinate stage commands and image rotator commands.

27. A method for viewing an object, comprising:
mounting the object on a theta-theta coordinate stage;
viewing an image of a region of the object;
using the theta-theta coordinate stage to move the object; and
rotating the image of the object as the object moves so that features in the image retain a fixed orientation while the object rotates.

28. A measuring device comprising:
a theta-theta coordinate stage including a rotatable platform for mounting of a sample;
an alignment system including an edge detector and a processing system that identifies a position of the sample from measurements that the edge detector takes while the theta-theta coordinate stage rotates the sample;
a measurement system for measuring a physical property of a portion of the sample that the theta-theta coordinate stage moved into a field of view of the measurement system;
an imaging system for obtaining an image of a portion of the sample that the theta-theta coordinate stage moved into a field of view of the imaging system; and
an image rotator that rotates the image to compensate for rotation of the sample by the theta-theta coordinate stage.

29. The measuring device of claim 28, wherein the alignment system further comprises a pattern recognition module that identifies a feature in the image as rotated by the image rotator and from identification of the feature, determines a position of the sample.

30. The measuring device of claim 28, wherein the imaging system includes a video camera and the image rotator rotates a video image from the video camera.

31. The measuring device of claim 28, wherein the image rotator comprises an optical element for rotating the image.

32. The measuring device of claim 28, wherein the alignment system further comprises a pattern recognition module that identifies a feature in the image and determines a position of the sample.

33. A measuring method comprising:
mounting a sample on a theta-theta coordinate stage, wherein the sample as mounted has a position known to a first accuracy;
measuring edge locations of the sample while the theta-theta coordinate stage rotates the sample;
prealigning the sample by determining the position of the sample from the edge locations, wherein the prealigning determines the position of the sample to a second accuracy;
using the theta-theta coordinate stage to move the sample so that a view area of an imaging system contains a first feature;
rotating an image formed by the imaging system to compensate for rotation of the sample by the theta-theta coordinate stage;
using a pattern recognition module to process the rotated image and identify a first location corresponding to the first feature; and
measuring a property of the sample at a point having a position identified relative to the first location.

34. The method of claim 33, further comprising:
using the theta-theta coordinate stage to move the sample so that the view area of the imaging system contains a second feature;
rotating the image formed by the imaging system to compensate for a rotation of the sample by the theta-theta coordinate stage while moving to the second feature;
using the pattern recognition module on the rotated image to identify a second location corresponding to the second feature; and
using identification of the first and second locations to determine the position of the sample to a third accuracy.

35. The method of claim 33, further comprising:
using the theta-theta coordinate stage to move the sample so that a plurality of points are sequentially positioned for measurement of the property of the sample at the points; and
sequentially measuring the property of the sample at the measurement points.

36. A device comprising:
a rotary platform for rotating the object;
one or more secondary rotary drives for moving a sensor across the rotating object;
one or more sensors mounted to one or more rotary drives;
a control system for controlling the position of the object while acquiring the sensor data.

37. The device in claim 36, whereas at least one of the sensors is used to inspect the top surface of the object, and at least one sensor is used to inspect the bottom surface of the object.
